(19) United States
(12) Patent Application Publication
(10) Pub. No.: US 2006/0065359 A1
(43) Pub. Date: Mar. 30, 2006

(54) Manufacturing method for EVA foam cushion with surface plastic film

(76) Inventor: Allan Kuan, Lindfield (AU)

Correspondence Address: ROSENBERG, KLEIN & LEE, 3458 ELLICOTT CENTER DRIVE-SUITE 101, ELLICOTT CITY, MD, 21043, US

(21) Appl. No.: 10/950,621

(22) Filed: Sep. 28, 2004

(51) Int. Cl. B29C 65/00; B32B 37/00

(52) U.S. Cl. 156/272.6; 156/277; 156/275.5

(57) ABSTRACT

A manufacturing method for EVA foam cushion with surface plastic film, including steps of: discharge treatment of plastic film: applying discharge treatment to inner face of a transparent plastic film to form a rough face on the inner face of the plastic film for enhancing the adhesion; printing: printing an ink layer on the rough face; and gluing and adhering: painting a glue onto the other face of the ink layer or the surface of the EVA foam cushion and then thermally pressing and adhering the plastic film to the surface of the EVA foam cushion.

### BACKGROUND OF THE INVENTION

The present invention is related to a manufacturing method for EVA foam cushion with surface plastic film, and more particularly to a method for enhancing the adhesion of the inner face of the plastic film.

The surface of a conventional ethylene vinyl acetate (EVA) foam cushion is often printed with a colorful picture for beautifying the appearance of the EVA cushion. Such colorful picture tends to detach from the surface of the EVA foam cushion due to friction. Therefore, a measure has been developed to solve the problem of detachment as follows:

A soft transparent plastic film 8 is applied to the EVA foam cushion. A first glue layer 81 is painted on inner face of the transparent plastic film 8. Then, an ink layer 82 is printed on the other face of the first glue layer 81. A second glue layer 83 is painted on the other face of the ink layer 82. Then, a third glue layer 91 is painted on the surface of the EVA foam cushion 9. Finally, the second glue layer 83 of the transparent plastic film 8 is attached to the third glue layer 91 of the EVA foam cushion 9 and thermally pressed and adhered to the EVA foam cushion 9 as shown in FIG. 5.

In the above structure, the transparent plastic film 8 forms a protective layer of the ink layer 82 so as to achieve an anti-abrasive effect and prevent the colorful picture from detaching from the EVA foam cushion 9. The transparent plastic film 8 has a polished surface and properties quite different from those of the ink layer 82 so that the ink layer 82 can be hardly directly attached to the surface of the transparent plastic film 8. Therefore, prior to printing the ink layer 82, it is necessary to first paint the first glue layer 81 on the inner face of the transparent plastic film 8 and then print the ink layer 82 on the first glue layer 81 to enhance the adhesion of the ink layer 82.

However, the surface of the transparent plastic film 8 is so polished that the property of the first glue layer 81 must be very similar to the property of the transparent plastic film 8 for effectively adhering the first glue layer 81 onto the transparent plastic film 8. Even if a glue with a property very similar to the property of the transparent plastic film 8 is selected, the thickness of the first glue layer 81 will still affect the ink layer 82. In the case that the first glue layer 81 is too thick, after the ink layer 82 is adhered to the first glue layer 81, in the thermally pressing and adhesion procedure, the first glue layer 81 tends to soften and displace. This will lead to fogging of the printed picture. In the case that the first glue layer 81 is too thin, the adhesion between the first glue layer 81 and the polished transparent plastic film 8 will be too low. As a result, the ink layer 82 will be poorly adhered to the transparent plastic film 8. In the case that the first glue layer 81 has uneven thickness, the entire ink layer 82 will be unevenly adhered to the transparent plastic film 8. Therefore, it is necessary to very accurately and evenly control the painting of the first glue layer 81. This makes it more difficult to manufacture the EVA cushion so that the manufacturing cost is relatively high.

### SUMMARY OF THE INVENTION

It is therefore a primary object of the present invention to provide a manufacturing method for EVA foam cushion with surface plastic film. According to the manufacturing method, a discharge treatment is applied to inner face of a transparent plastic film to roughen the inner face of the plastic film so as to enhance the adhesion of the ink layer or glue layer. By means of this method, the manufacturing procedure is simplified and the cost is lowered.

According to the above object, the manufacturing method for EVA foam cushion with surface plastic film comprising steps of:
(1) discharge treatment of plastic film: applying discharge treatment to inner face of a transparent plastic film to form a rough face on the inner face of the plastic film;
(2) printing: printing an ink layer on the rough face; and
(3) gluing and adhering: painting a glue onto the other face of the ink layer or the surface of the EVA foam cushion and then thermally pressing and adhering the plastic film to the surface of the EVA foam cushion.

The present invention can be best understood through the following description and accompanying drawings wherein:

### BRIEF DESCRIPTION OF THE DRAWINGS

FIG. 1 is a flowchart of the present invention;

FIG. 2 is a sectional view showing the structure of the product of the present invention;

FIG. 3 is a flowchart of a second embodiment of the present invention;

FIG. 4 is a flowchart of a third embodiment of the present invention; and

FIG. 5 is a sectional view showing the structure of a conventional EVA foam cushion.

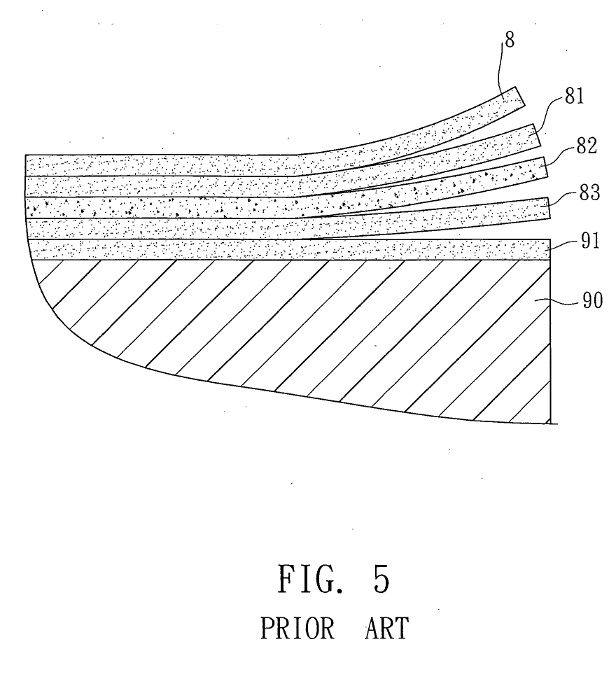

### DETAILED DESCRIPTION OF THE PREFERRED EMBODIMENTS

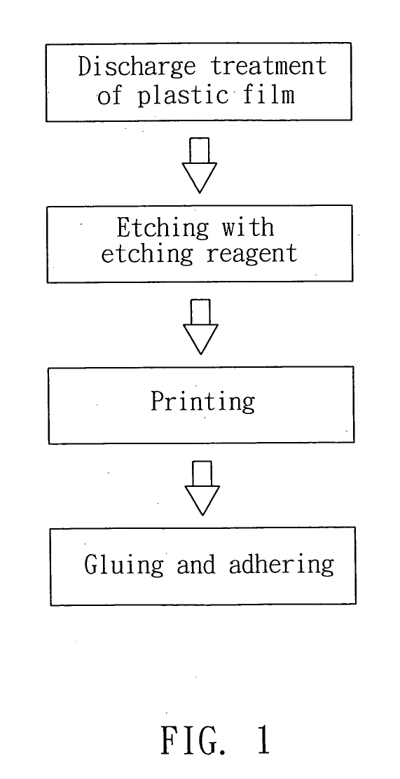

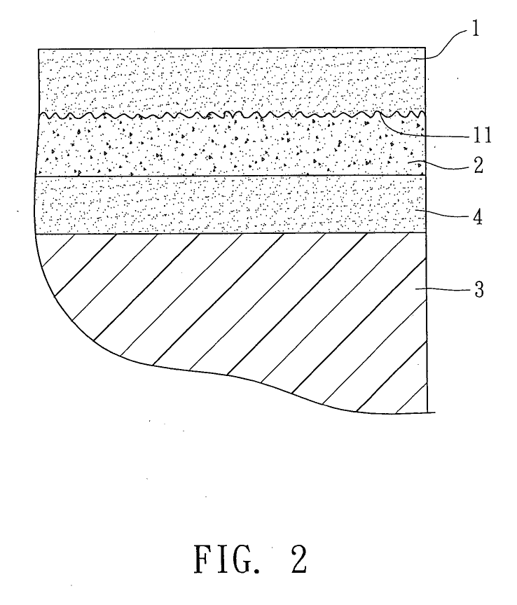

Please refer to FIGS. 1 and 2. The manufacturing method for EVA foam cushion with surface plastic film of the present invention includes steps of:
1. discharge treatment of plastic film: applying discharge treatment to inner face of a transparent plastic film 1 made from one of PE, PEVA and PP to form a rough face 11 on the inner face of the plastic film 1;
2. etching with etching reagent: using an etching reagent to etch the rough face 11 of the plastic film 1 to enhance the roughness of the rough face 11;
3. printing: printing an ink layer 2 on the rough face 11; and
4. gluing and adhering: painting a glue 4 onto the other face of the ink layer 2 or the surface of the EVA foam cushion 3 and then thermally pressing and adhering the plastic film 1 to the surface of the EVA foam cushion 3.

In the step of gluing and adhering of the method of the present invention, the glue 4 is painted on one of the adhered faces, that is, the surfaces of the ink layer 2 and the EVA foam cushion 3 to integrally adhere the ink layer 2 and the EVA foam cushion 3 to each other. Alternatively, the surfaces of the ink layer 2 and the EVA foam cushion 3 can be both painted with the glue and then thermally pressed and adhered. This measure can also integrally adhere the ink layer 2 and the EVA foam cushion 3 to each other.

In the method of the present invention, the discharge treatment is first applied to the inner face of the transparent plastic film 1 to form the rough face 11 on the inner face of the plastic film 1 for enhancing the adhesion of the ink layer 2. Accordingly, it is no more necessary to very accurately and evenly paint the first glue layer on the inner face of the plastic film as in the conventional method. Therefore, the difficulty in manufacturing is reduced and the cost is lowered.

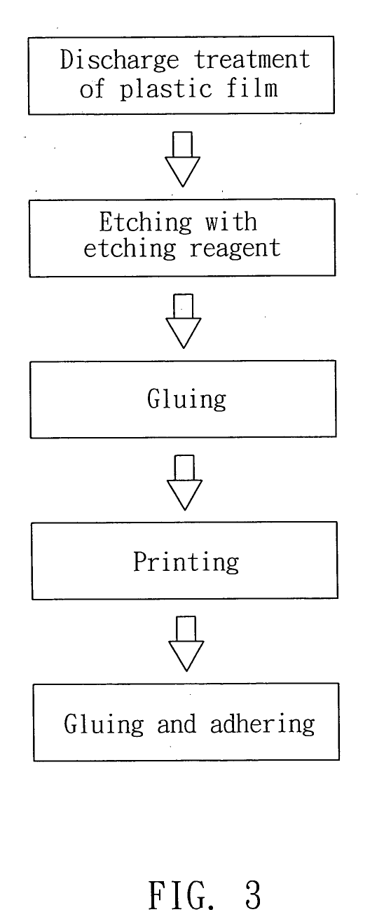

FIG. 3 is a flowchart showing a second embodiment of the present invention, which includes steps of: discharge treatment of plastic film; etching with etching reagent; gluing the rough face to form a glue layer; printing an ink layer on the glue layer; and gluing the ink layer or the surface of the EVA foam cushion to integrally adhere the ink layer 2 and the EVA foam cushion to each other.

In the second embodiment, a step of gluing the rough face to form a glue layer is added. Since the inner face of the plastic film has been roughened, only a thin glue layer is necessary for well adhering the ink layer to the inner face of the plastic film. It is unnecessary to accurately control the painting of the glue layer as in the conventional method. Therefore, the manufacturing procedure is simplified to achieve the same effect as the first embodiment.

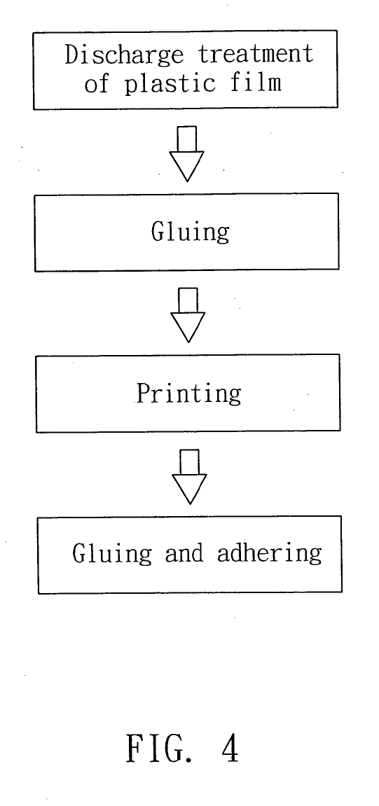

FIG. 4 is a flowchart showing a third embodiment of the present invention, which includes steps of: discharge treatment of plastic film; gluing the rough face to form a glue layer; printing an ink layer on the glue layer; and gluing the ink layer or the surface of the EVA foam cushion to integrally adhere the plastic film with the ink layer and the EVA foam cushion to each other. This can achieve the same effect as the above two embodiments.

The above embodiments are only used to illustrate the present invention, not intended to limit the scope thereof. Many modifications of the above embodiments can be made without departing from the spirit of the present invention.

What is claimed is:

1. A manufacturing method for EVA foam cushion with surface plastic film, comprising steps of:
(1) discharge treatment of plastic film: applying discharge treatment to inner face of a transparent plastic film to form a rough face on the inner face of the plastic film;
(2) etching with etching reagent: using an etching reagent to etch the rough face of the plastic film to enhance the roughness of the rough face;
(3) printing: printing an ink layer on the rough face; and
(4) gluing and adhering: painting a glue onto the other face of the ink layer or the surface of the EVA foam cushion and then thermally pressing and adhering the plastic film to the surface of the EVA foam cushion.

2. The manufacturing method as claimed in claim 1, further comprising a step of gluing the rough face of the plastic film to form a glue layer before the step of printing, after a glue is painted on the rough face of the plastic film to form a glue layer, the ink layer being printed on the glue layer.

3. The manufacturing method as claimed in claim 1, wherein the transparent plastic film is made from one of PE, PEVA and PP.

4. A manufacturing method for EVA foam cushion with surface plastic film, comprising steps of:
(1) discharge treatment of plastic film: applying discharge treatment to inner face of a transparent plastic film to form a rough face on the inner face of the plastic film;
(2) gluing: painting a glue on the rough face of the plastic film to form a glue layer;
(3) printing: printing an ink layer on the other face of the glue layer; and
(4) gluing and adhering: painting a glue onto the other face of the ink layer or the surface of the EVA foam cushion and then thermally pressing and adhering the plastic film to the surface of the EVA foam cushion.
